(19) United States
(12) Patent Application Publication
(10) Pub. No.: US 2006/0095359 A1
(43) Pub. Date: May 4, 2006

(54) Computer arrangement and a method for the determination of an RoH value dependent on non-monetary factors of a company

(75) Inventors: Curt-Michael Stoll, Esslingen (DE); Matthias Kolb, Unterensingen (DE); Hermann Neher, Aichwald (DE); Petra Passen, Esslingen (DE); Klaus Utfeld, Bexbach (DE); Boris Worter, Kirchheim (DE)

Correspondence Address: HOFFMANN & BARON, LLP, 6900 JERICHO TURNPIKE, SYOSSET, NY, 11791, US

(73) Assignee: Festo AG & Co.

(21) Appl. No.: 11/264,116

(22) Filed: Oct. 31, 2005

(30) Foreign Application Priority Data
Nov. 3, 2004 (DE) 10 2004 052915.9

(51) Int. Cl. G06Q 40/00

(52) U.S. Cl. 705/35

(57) ABSTRACT

A method and a computer arrangement, more particularly a data base module, for the determination of an RoH value, dependent on non-monetary factors of a company, as related to a monetary value of the company, which includes, means for the determination of a human capital factor as a first non-monetary factor on the basis of competence characteristics and/or satisfaction characteristics of persons employed by the company, means for the determination of a relationship capital factor as a second non-monetary factor on the basis of at least one relation characteristic for a company-internal relation characteristic and/or for a company-external relation, means for the determination of a structural capital factor as a third non-monetary factor in a manner dependent on at least one structural characteristic dependent on the structure of the company, and means for the determination of the RoH value in a manner dependent on the first, second and third non-monetary factors and on a material value and/or a capitalized value of potential earnings of the company.

### CROSS-REFERENCE TO RELATED APPLICATION

This application claims priority based on German Patent Application No. 10 2004 052 915.9, filed on Nov. 3, 2004, which is incorporated herein by reference.

### FIELD OF THE INVENTION

The invention relates to a computer arrangement and more particularly a data base module and furthermore to a method for the determination of an RoH value, dependent on non-monetary factors of a company, as related to a monetary value of the company.

### BACKGROUND OF THE INVENTION

The value of a company is normally set by factors, which can be measured on the basis of cash flow, real values or the like. For instance in the case of a company the assets or also the material value are taken as a basis. An asset comprises for example values for real estate of the company. Moreover, it is possible to determine the capitalized value of potential earnings of a company, taking the operating income of the company for example as a basis. The efficiency of the company may be determined on the basis of various characteristics, for example as related to a profit and loss quota as regards investments, return on investments (RoI) and as regards net profit margins, return on sales (RoS) or the like.

To an increasing degree however other factors are becoming relevant for a company, as for example the ability of its employees or other factors. In order to assess the efficiency of this resource and of other non-monetary factors of the company there have so far been no tools. Accordingly it is not possible to determine a value dependent on non-monetary factors of the company, that is to say a so-called return on human resources (RoH) value and/or a return on intellectual capital (RoIC) of the company.

### SUMMARY OF THE INVENTION

Accordingly one object of the present invention is to provide a computer arrangement and more especially a data base module and furthermore a method for determining an RoH, dependent on non-monetary factors of a company, as related to a monetary value of the company.

This aim is to be achieved by a computer arrangement and more particularly a data base module, for the determination of an RoH, dependent on non-monetary factors of a company, as related to a monetary value of the company, comprising:

means for the determination of a human capital factor as a first non-monetary factor on the basis of competence characteristics and/or satisfaction characteristics of persons employed by the company,

means for the determination of a relationship capital factor as a second non-monetary factor on the basis of at least one relation characteristic for a company-internal relation characteristic and/or for a company-external relation,

means for the determination of a structural capital factor as a third non-monetary factor in a manner dependent on at least one structural characteristic dependent on the structure of the company, and

means for the determination of the RoH value in a manner dependent on the first, second and third non-monetary factors and on a material value and/or a capitalized value of potential earnings of the company. Furthermore, to attain the aim of the invention a corresponding method in accordance with the invention is provided.

A significant principle of the present invention is to be able to ascertain a monetary value of the company, dependent on non-monetary factors, on the basis of measurable or, respectively, determinable characteristics, as for example competence characteristics, satisfaction characteristics or the like. In accordance with the invention the RoH value and/or an RoIC value involves not only the “human capital” of the company but also the company's relation capital, expressed by its external and also internal relations and also the structural capital of the company, i.e. the capital dependent inter alia on the structure, for example the organization, the type of processes and furthermore the methods employed within the company. The RoH value is in accordance with the invention constituted in a manner dependent on a material value or a capitalized value of potential earnings of the company. Accordingly the non-monetary factors are set in relation to monetary values, namely the material value or, respectively, the capitalized value of potential earnings of the company. The RoH value is thus a relative value. In principle it would be possible in accordance with the invention as well to determine the RoH value as an absolute value.

The first, second and third non-monetary factors are preferably weighted in order to form the RoH value. This means that, dependent on the weighting, the human capital, the relation capital or the structural capital have a greater or smaller influence on the RoH value of the company. It is particularly advantageous too for the characteristics, on the basis of which the first, second and third factors are formed, to be weighted so that a first characteristic may have a greater influence on the respective factor than a second characteristic.

In accordance with the invention it is an advantage for changes in the RoH value with time to be determined. Accordingly the changes with time of the non-monetary value of the company may be emphasized in a graph. In this respect a version is preferred in which the non-monetary value is linked with monetary values of the company and/or is related to them.

In a further aspect as well a time-related form of the RoH value is appropriate. As an advantageous version of the invention it is proposed that the respective RoH value be related to a fiscal period. For instance for a first fiscal period an RoH value is formed and is validated on the basis of this first fiscal period. It is in this manner that it is possible to ascertain whether the first, second and third non-monetary factors are appropriate for determining the RoH value, for example whether the characteristics are suitable and whether weighting factors or the like are suitable. On the basis of a second fiscal period a second RoH value is determined. The second fiscal period is for example a second fiscal year following a first fiscal year of the company. It is then possible to validate whether the first, second and third non-monetary factors, which have been employed to determine the second RoH value, are correct. As part of a further advantageous step it is possible, on the basis of such a weighted and validated RoH value, to make a forecast for the future, i.e. a future RoH value. Accordingly future developments of the non-monetary share in the value of the company may be estimated or foreseen. A further step is preferably included, namely determining on the basis of varied characteristics how the RoH value will progress in the future, whether one or the other characteristic is changed. For instance, in such a simulation scenario it is possible to ascertain whether the increase of competence characteristics will have a greater influence on the RoH value in future than the improvement in one or more relation characteristics for the company.

The characteristics are preferably determined as the difference between target and true values.

It is also appropriate for the computer arrangement to have one or more interfaces for the entry of characteristics or statistical data relating to the company. For example, one interface may be an interface for a personnel data base and/or a statistical data base and/or a balance data base for the company so that the computer arrangement in accordance with the invention can receive the respective data from the data bases and/or transmit same to such data bases.

A particularly preferred version of the invention contemplates the computer arrangement constituting a management tool for the company. The computer arrangement or, respectively, the data base module is then suitable for use as an aid for the management of the company in its operations. They preferably constitute a navigation and/or early warning system for the company. In the case of this version of the invention it is more particularly preferred for information and/or warning messages be generated when certain limiting values are exceeded or gone below for the first, second and third factors. This is more especially appropriate as regards prognostic values so that suitable remedial steps may be taken in good time by the management of the company. Moreover, with the aid of the computer arrangement or, respectively, data base module of the invention, it is possible for the company to be optimized so that more particularly non-monetary potentials of the company are recognized, developed farther and employed for the creation of values. On the basis of the invention long terms company planning is more readily possible.

The computer arrangement or, respectively, the data base module preferably comprise program code able to be executed by a processor. It will be clear that the invention is also able to be realized by one or more software modules.

Further advantageous developments and convenient forms of the invention will be understood from the following detailed descriptive disclosure of one embodiment thereof in conjunction with the accompanying drawings.

### BRIEF DESCRIPTION OF THE DRAWINGS

FIG. 1 diagrammatically shows a computer arrangement for the performance of the method of the invention.

FIG. 2 diagrammatically shows the timing of the determination of an RoH value using the computer arrangement in accordance with FIG. 1.

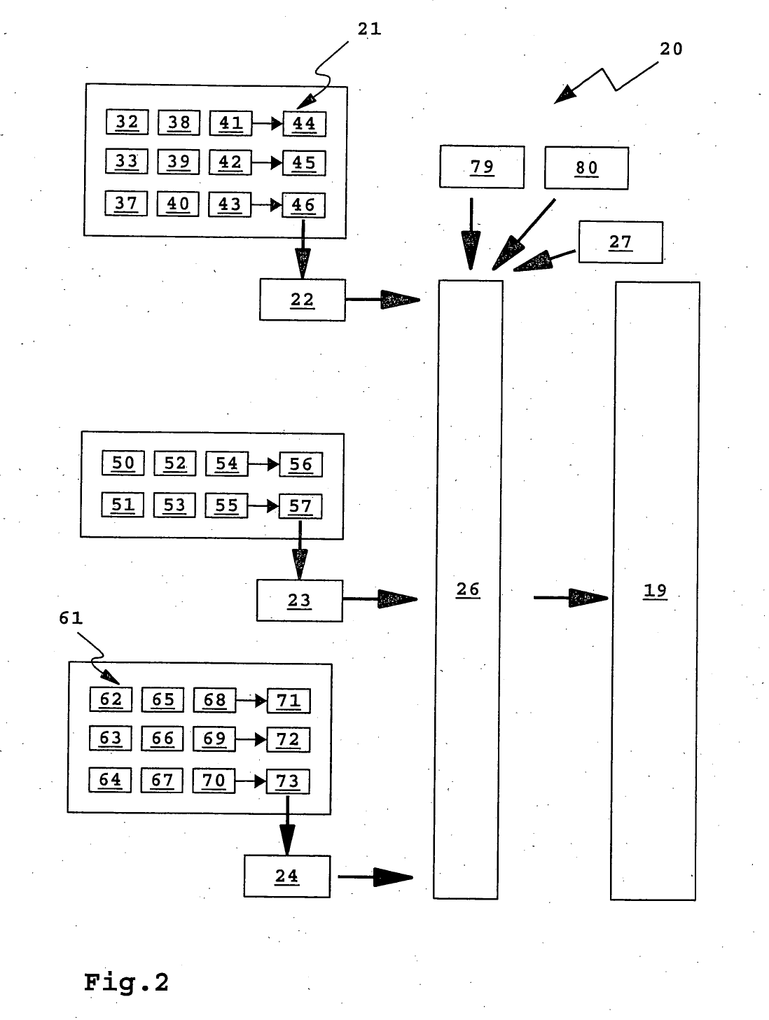

FIG. 3 diagrammatically shows the course of changes in an RoH value, ascertained in accordance with the invention, relating to several fiscal periods.

### DETAILED DESCRIPTION OF THE PREFERRED EMBODIMENTS

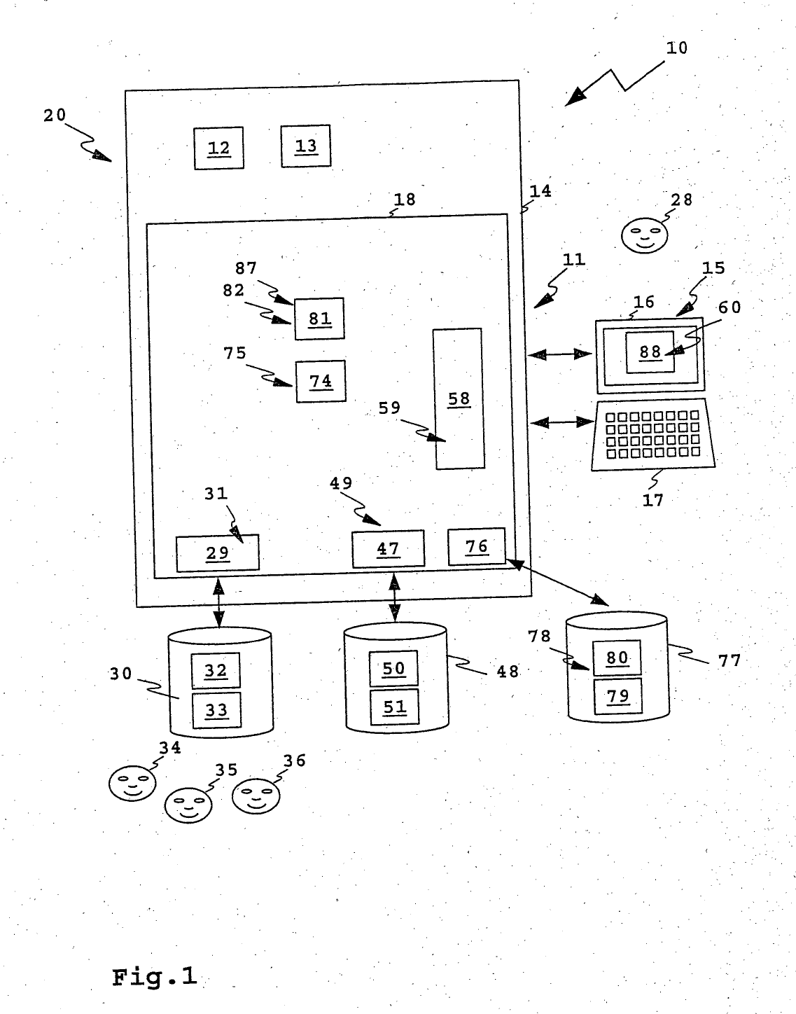

FIG. 1 shows a computer arrangement generally referenced 10. The computer arrangement 10 can comprise one or more computers preferably placed in a network with each other. For the sake of simplicity in the working example the arrangement only comprises one computer 11, f. i. a personal computer. The computer 11 includes one or more processors 12, memory means 13, f. i. random access memories (RAM) or read only memories (ROM), hard disk drives or the like, arranged in a housing 14 and input/output means 15, for example a display 16 and furthermore a keyboard 17. The processor 12 can execute program code from program modules, for example, from a data base module 18, which is stored in the memory means 13.

The data base module 18 serves in accordance with the invention for the determination of an RoH value 19 for the company 20, same in the working example including the computer arrangement 20. On the basis of a human capital factor 22, of a relationship capital factor 23, and a structural capital factor 24 the data base module 18 generates an RoH value 26, for instance by multiplication or summation of the factors 22 through 24. The data base module 18 relates the RoH value 26 to a material value 79 and/or a capitalized value 80 of potential earnings of the company 20, for instance by a multiplication and thus determines the RoH value 19, i.e. a monetary value for the peer se non-monetary, but value constituting, first second and third factors 22, 23 and 24 of the company 20. In this respect it is optionally possible for the data base module 18 to weight the RoH value 26 with a weighting factor 27. Thus the share of the non-monetary factors in the value of the company 20 is able to be set by an operator 28 in the computer arrangement 10.

An interface 29 to a personal computer 30 of the company 20 is a component of means 31 for the determination of the human capital factor 22. In the personnel data base 30 competence characteristics 32 and satisfaction characteristics 33 for employees 34, 35 and 36 of the company 20 are for example held in the personnel data base 30. Competence characteristics 32 relate for example to qualities, which the employees 34, 35 and 36 have, f. i. their respective qualifications, their future potential, their degree of training (f. i. a skilled worker or an employee with an academic education) or the like. Furthermore other values, which are for example found in employee interviews or the like may be ascertained, held in the personnel data base 30 and made available as characteristics for the data base module 18. One example for this is constituted by the satisfaction characteristics 33 representing the satisfaction of the employees 34 through 36. The satisfaction characteristics 33 may for example be a health quota and a fluctuation quota (also able to be included in the term knowledge loss quota) and a quota for time-limited activities of the employees 34 through 36.

A flexibility characteristic 37, also evaluated by the data base module 18 to determine the human capital factor 22, represents for example the time-related flexibility and/or relocation and/or professional flexibility of the employees 34 through 36. This flexibility, f. i. as regards time, is able to be determined on the basis of an overtime quota and/or a flexibility coefficient. A relocation flexibility may be determined f. i. by determining a ratio between employees 34 through 36 relocated in the company and those 34 through 36 who are not relocated. A professional flexibility is f. i. able to be measured on the basis of co-operation of one or more employees 34 through 36 in an interdisciplinary project team. The relocation and/or professional flexibility may be included in the flexibility coefficient.

On the basis of a target state/true state comparison involving true values 38, 39 and 40 the data base module determines (for example by forming difference values and weighting them using weighting factors 41, 42 and 43) indices 44 through 46 to determine the human capital factor 22. The weighting factors 41 through 43 yield, for example, a sum of unity so that the data base module 18 may add the indices 44 through 46 to form the factor 22. Accordingly, when determining the human capital factor 22, the data base module 18 in the working embodiment, firstly performs a target/true state comparison for the respective characteristics, which are taken as a basis for the factor 22, then performs weighting and finally performs summation to determine the factor 22.

An interface 47 connects the computer arrangement with a statistical data base arrangement 48 which in principle can also constitute a component of the computer arrangement 10. The interface 47 is a component of means 49 for the determination of the relationship capital factor 23. In the statistical data base 48 characteristics are stored, which involve external relations of the company 20, for example with customers, and internal relations of the company 20. The characteristics can for example also comprise a cooperation index and furthermore a characteristic for strategic alliances of the company 20 with other companies. The statistical data base 48 comprises for instance customer satisfaction characteristics 50 of customers of the company 20 and complaint characteristics 51 for complaints by the employees 34 through 36, which are compared by the data base module 18 with corresponding target values 52 and 53, and the data base module weights same with weighting factors 54 in order to form indices 56 and 57. The weighting factors 54 and 55 yield the sum of unity and the indices 56 and 57 yield the sum equal to the relationship capital factor 23. It will be clear that the data base module 18 may also apply further characteristics for determining the relationship capital factor, as for example characteristics relevant for the public image of the company 20 and/or characteristics for participation of the company's employees in voluntary activities run by the company 20, for example membership in company sport clubs or the like. Furthermore the international character, i.e. for example the number of countries, in which the company 20 has production and/or marketing facilities, may be included in the relationship capital factor 23.

Mutatis mutandis the data base module 18 determines the structural capital factor 24. An acquisition means 58 is a component of means 59 for determination of the structural capital factor 24. In the acquisition means 58 there is a graphical user interface 60 for the operator 28 to enter structural characteristics 61, for example, in the data base module 18. The structural characteristics 61 for example comprise a characteristic 62 representing informal structures, the average management span for a hierarchy level of the company 20. A characteristic 63 represents formal structures of the company 20, f. i. the regional differentiation of the company 20, taking into account the average number of employees in the respective country as relating to the total number of employees in the company 20.

A further characteristic 64 of the structural characteristics 61 represents for example the personnel structure of the company 20, the share of academically educated employees, of skilled workers, of engineers or the like being taken into account.

In the above described fashion the data base module 18 implements a target/true value comparison for the characteristics 62 through 64 using target values 65 through 67 and weights the differential values so obtained with weighting factors 68 through 70 in order to set indices. The indices 71 through 73 undergo summation in the data base module 18 to yield the structural capital factor 24.

One function 74 of the data base module 18 forms a means 75 to determine the RoH value 19. The function 74, for example a program function, consolidates the factors 22, 23 and 24 as the RoH value 26. In this case it is in principle possible for the function 74 to differently weight the factors 22, 23 and 24, the respective weighting factors being for example able to be set with the aid of the user interface 60 by the user 28.

The data base module 18 possesses an interface 76 to a balance data base 77 in which the balance data 78 are stored, as for example a material value 79 and a capitalized value 80 of potential earnings for the company 20. The data base module 18 relates the RoH factor 26 to the material value 79 and/or the capitalized value 80 of potential earnings, for example by multiplication, and thus determines the RoH value 19 of the company 20. It will be clear that the respective values 79 and 80 are able to be transmitted to the data base module 18, for example at the user interface 60.

The output of the RoH value 19 by the data base module 18 is for example at the user interface 60.

It will be clear that the above mentioned characteristics are advantageously automatically, as it were, acquired by the data base module 18. For instance the personnel data base automatically transfers a change in the characteristics 32 and 33 to the data base module 18 which then adapts the RoH factor 26 and ultimately furthermore the RoH value 19 to the changed characteristics. Accordingly every change in characteristics for the company 20 is directly detected so that the current RoH value 19 of the company 20 is available at any time.

In this manner it is possible for the company 20 to be managed efficiently. A change in the RoH value 19 is directly recognizable so that suitable measures, to the extent they are necessary, may be started for the correction or respectively improvement of the RoH value 19. Moreover the RoH value 19 is a suitable means for representing the non-monetary values of the company 20 externally as well, something which for example is an advantage for example for loan negotiations, for evaluation of shares in the company 20 or the like.

The data base module 18 possesses a calibration, validation and prognostic function 81 which forms a calibration, validation and prognostic means 82 for calibration and validation of the RoH value 19 as regards fiscal periods 83 through 85. The fiscal periods 83 through 86 are for example fiscal quarters or fiscal years of the company 20.

The prognostic function firstly determines a first RoH value 19a for the fiscal period 83 (which lasts until the point T1 in time) related to a material value 79a of the company 20 applying for the fiscal period 83. In this case for example the weighting factors 27, 41, 42, 43, 68, 69 and 70 are set. The RoH value 19a is calibrated as it were.

During the fiscal period 84 the material value 79 rises to a value 79b. Furthermore the characteristics, on which the factors 22, 23 and 24 are based, change so that the data base module 18 determines an RoH value 19b for the fiscal period 84. The data base module 18 now validates the RoH value 19b by comparing this value for example with values for the average value added of an employee of the company 20 per man hour. This additional value added is also termed the economic value added (EVA). If the relation between the EVA value and the RoH value 19b is correct the weighting factors, for example the factors 41, 42 and 43, are correctly set.

On the basis of the validated values it is possible for the data base module 18, and more especially the prognosis function 81, to make a prognosis of the RoH values 19c and 19d for the fiscal periods 85 and 86, forecast material values 79c and 79d being taken as a basis. In the working embodiment for example a scenario is f. i. represented in which while the material value of the company 20 has sunken in the fiscal period 86, the RoH value 19 has nevertheless increased. This is for example achieved by qualification measures for the company's employees 34 through 36, by improvements in structure in the company 20, by an improvement in the relations between the company and its customers and/or shareholders and/or stakeholders or by an improvement in operation-internal or, respectively, company-internal relations and/or external alliances.

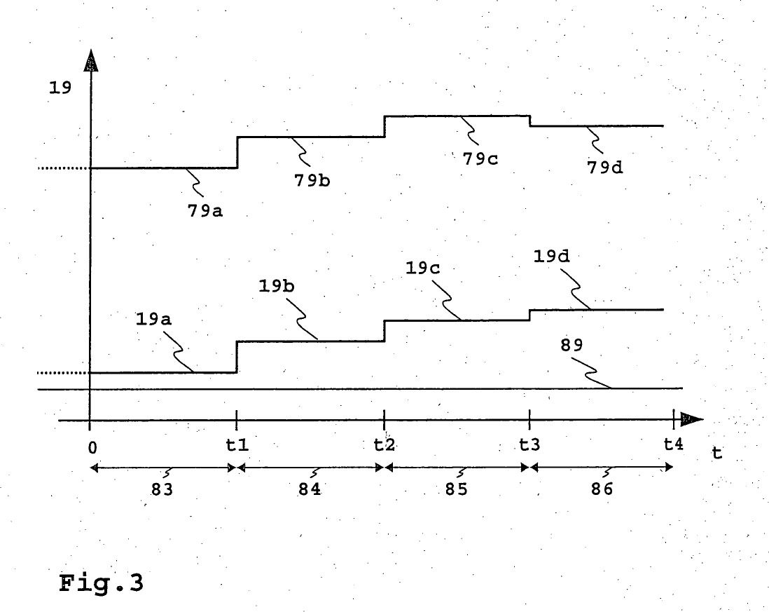

The prognostic function 81 forms a means 87 for the determination of a time-related change in the RoH value 19, for example the change indicated in FIG. 3, which for example is indicated at the user interface 60. The user interface 60 comprises a warning means 88 to generate a acoustic warning, f.i., signal when the RoH value 19 is below or above a predetermined limiting value 89.

It will be clear that the data base module 18 or, respectively, the computer arrangement 10 is able to be furthermore developed in many different ways or may be expanded using further characteristics. For instance, the patent remunerations paid in the company 20, the patents issued or the like may be taken as basic characteristics. Moreover, the inclusion of the computer arrangement 10 in business administration control software of the company is appropriate. It will be clear that the computer arrangement 10 and/or the data base module 18 may form part of business administration software, as for example SAP R2 or R3 or can cooperate with such software. Furthermore an interface may be present to balanced card software, to which the data base module 18 transfers characteristics, RoH value or the like. Furthermore the RoH value may be set in relation to macroeconomic values.

What is claimed is:

1. A computer arrangement and more particularly a data base module and furthermore to a method for the determination of an RoH value, dependent on non-monetary factors of a company, as related to a monetary value of the company, comprising:
means for the determination of a human capital factor as a first non-monetary factor on the basis of competence characteristics and/or satisfaction characteristics of persons employed by the company;
means for the determination of a relationship capital factor as a second non-monetary factor on the basis of at least one relation characteristic for a company-internal relation characteristic and/or for a company-external relation;
means for the determination of a structural capital factor as a third non-monetary factor in a manner dependent on at least one structural characteristic dependent on the structure of the company; and
means for the determination of the RoH value in a manner dependent on the first, second and third non-monetary factors and on a material value and/or a capitalized value of potential earnings of the company.

2. The computer arrangement as set forth in claim 1, wherein the means for weighting the first and/or second and/or third non-monetary factor are formed in the determination of the RoH value.

3. The computer arrangement as set forth in claim 1, comprising means for determination of a change with time of the RoH value.

4. The computer arrangement as set forth in claim 1, comprising means for the determination of a first RoH value in relation to a first fiscal period of the company and a second RoH value in relation to a second fiscal period of the company, and means for calibration of the first, second and third non-monetary factors in relation to the first fiscal period and for validation of the first, second and third non-monetary factors in relation to the second fiscal period of the company.

5. The computer arrangement as set forth in claim 4, comprising prognostic means for forecasting an RoH value for a third fiscal period.

6. The computer arrangement as set forth in claim 1, wherein same is designed to form the competence characteristics and/or the satisfaction characteristics and/or the at least one relation characteristic and/or the at least one structural characteristic as differential values between true values and target values.

7. The computer arrangement as set forth in claim 1, wherein same is designed for weighting the characteristics on the determination of the first and/or second and the third non-monetary factor.

8. The computer arrangement as set forth in claim 1, comprising an interface to a personnel data bank in which personnel data of the company are held or able to be held.

9. The computer arrangement as set forth in claim 1, comprising an interface to a statistics data bank in which statistical data of the company are held or able to be held.

10. The computer arrangement as set forth in claim 1, comprising an interface to a balance data bank in which balance data of the company are held or able to be held.

11. The computer arrangement as set forth in claim 1, comprising a warning means adapted, when a predetermined limiting value of the RoH value and/or of the human capital factor and/or of the relationship capital factor unit of the structural capital factor is gone below, to generate a warning message.

12. A computer arrangement and more particularly a data base module, as set forth in claim 1, comprising a program code able to be implemented by a processor.

13. A storage medium with a computer arrangement and more particularly a data base module as set forth in claim 12.

14. A method for the determination of an RoH value dependent on non-monetary factors of a company as related to a monetary value of the company comprising the steps of:
determination of a human capital factor as a first non-monetary factor on the basis of competence characteristics and/or satisfaction characteristics of persons employed by the company;
determination of a relationship capital factor as a second non-monetary factor on the basis of at least one relation characteristic for a company-internal relation characteristic and/or for a company-external relation;
determination of a structural capital factor as a third non-monetary factor in a manner dependent on at least one structural characteristic dependent on the structure of the company; and
determination of the RoH value in a manner dependent on the first, second and third non-monetary factors and on a material value and/or a capitalized value of potential earnings of the company.
